(19) United States
(12) Patent Application Publication
(10) Pub. No.: US 2008/0112473 A1
(43) Pub. Date: May 15, 2008

(54) SYSTEM AND METHOD FOR COMMUNICATING WITH MULTI COMPARTMENT VEHICLES

(76) Inventors: Rami Refaeli, Kfar Saba (IL); Rafi Ben-Atar, Kochav Yair (IL)

Correspondence Address: MARTIN D. MOYNIHAN d/b/a PRTSI, INC., P.O. BOX 16446, ARLINGTON, VA, 22215, US

(21) Appl. No.: 11/936,808

(22) Filed: Nov. 8, 2007

Related U.S. Application Data
(60) Provisional application No. 60/864,985, filed on Nov. 9, 2006.

(30) Foreign Application Priority Data
Mar. 26, 2007 (CN) 200710090086.1

(51) Int. Cl. H04B 1/38

(52) U.S. Cl. 375/222

(57) ABSTRACT

An apparatus, system, and method are provided for communicating to, from and between multi compartmental vehicles. A communications system for a multi compartment vehicle may include a plurality of communications networks, at least one for each compartment of the vehicle, such that each communications network includes a power line communications modem; and at least one electric cable connecting two or more compartments, to enable data to be communicated via the electric cable between the compartments.

### CROSS REFERENCE TO RELATED APPLICATIONS

This application claims priority from U.S. Provisional Patent Application No. 60/864,985 filed NOVEMBER 09, 2006, entitled “SYSTEM AND METHOD FOR COMMUNICATING WITH VEHICLES”, which is incorporated in its entirety herein by reference.

This application claims priority from Chinese Patent Application No. 200710090086.1 filed MARCH 26, 2007, entitled “SYSTEM AND METHOD FOR COMMUNICATING WITH MULTI COMPARTMENT VEHICLES”, which is incorporated in its entirety herein by reference.

### BACKGROUND OF THE INVENTION

There are a variety of ways in which data communications are provided to vehicles and within vehicles. In many cases satellites are used to communicate with mobile vehicles, such as trains, ships and planes. Further, various methods are provided for communicating within vehicles, such as ships and trains. For example, wireless communications are often used to provide data communications to users of vehicles.

In cases where vehicles have multiple compartments, such as trains, it may be difficult to achieve efficient communication between compartments using wireless communications, due to penetration issues, and movement of compartments when in motion. Furthermore, such inter compartment communications may require setting up of multiple transmitter units in each compartment. Additionally, a problem may be created if a vehicle with multiple compartments is reconfigured, as each compartment is generally configured to communicate with selected neighbors, possibly leading to communications problems if the neighbors are changed.

In some cases fiber optic lines are used to communicate between compartments in a vehicle. However, compartments which have not been built with fiber optic capability generally have to be worked on substantially to add fiber optic communication capabilities. This may be at much cost and may cause much down time for usage of such vehicles.

It would be highly advantageous to have a method for enabling communications between and across multiple compartments in vehicles, where such communications may be implemented without substantial work on existing infrastructure, and where the resulting communications can be stable, and may be automatically configured.

### SUMMARY OF THE INVENTION

There is provided, in accordance with an embodiment of the present invention, an apparatus, system, and method for communicating to, from and between multi compartmental vehicles. According to some embodiments of the present invention, a communications system for a multi compartment vehicle is provided, that includes a plurality of communications networks, at least one for each compartment of the vehicle, wherein each communications network includes a power line communications modem; a plurality of electric cables connecting two or more compartments, to enable data to be communicated via the cables between the compartments.

Moreover, in accordance with an embodiment of the present invention, a communications system for a multi compartment vehicle is provided, which includes a plurality of communications networks, at least one for each compartment of the vehicle, wherein each communications network includes a power line communications modem; a plurality of electric cables connecting two or more compartments, to enable data to be communicated via the cables between the compartments; a transponder to enable communications between the vehicle and a communications satellite; and a network management system to manage the communications between the compartments.

Furthermore, in accordance with an embodiment of the present invention, a method is provided to enable data communications for multi-compartmental vehicles, including setting up a power line modem coupled to a communications network in a vehicle compartment; connecting a plurality of modems via an electricity grid, to form a power line communications network between a plurality of compartments; and communicating between a plurality of compartments of the vehicle via the electricity grid connecting the compartments.

In an additional embodiment, a method providing data communications for a multi-compartmental vehicle may include setting up a power line modem coupled to a communications network in a vehicle compartment; connecting a plurality of modems via communications cables to form a power line communications network between a plurality of compartments; and connecting said power line communication network to a transponder adapted to communicate with a communications satellite.

### BRIEF DESCRIPTION OF THE DRAWINGS

The principles and operation of the system, apparatus, and method according to the present invention may be better understood with reference to the drawings, and the following description, it being understood that these drawings are given for illustrative purposes only and are not meant to be limiting, wherein:

FIG. 1 is a schematic block diagram of a communication system, according to some embodiments of the present invention;

FIG. 2 is a schematic block diagram of a communication system, according to some embodiments of the present invention;

FIG. 3 is a flowchart illustrating a method of enabling data communications, according to some embodiments of the present invention; and

FIG. 4 is a flowchart illustrating a method of enabling data communications, according to some embodiments of the present invention.

It will be appreciated that for simplicity and clarity of illustration, elements shown in the drawings have not necessarily been drawn to scale. For example, the dimensions of some of the elements may be exaggerated relative to other elements for clarity. Further, where considered appropriate, reference numerals may be repeated among the drawings to indicate corresponding or analogous elements throughout the serial views.

### DETAILED DESCRIPTION OF THE INVENTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In other instances, well-known methods, procedures, and components have not been described in detail so as not to obscure the present invention.

In the following detailed description, numerous specific details are set forth in order to provide a thorough understanding of the present invention. However, it will be understood by those skilled in the art that the present invention may be practiced without these specific details.

The word “vehicle” as used herein may encompass any vehicle, conveyance or moving location that transports people or objects. For example, this may include vehicles with multiple rooms, areas or compartments, such as trains, trams, busses, airplanes, ships, liners, hydrofoils, submarines or other relevant transportation units. In some embodiments vehicle may include transportation apparatuses which include separate compartments or areas that may be connected via an electrical circuit.

Embodiments of the present invention may enable the formation of data networks in vehicles and between multi-compartmental vehicles. Other embodiment may enable the provision of Internet Access and other relevant data communication services to vehicles. Other services may also me enabled, such as security, monitoring, mapping, safety, maintenance, etc.

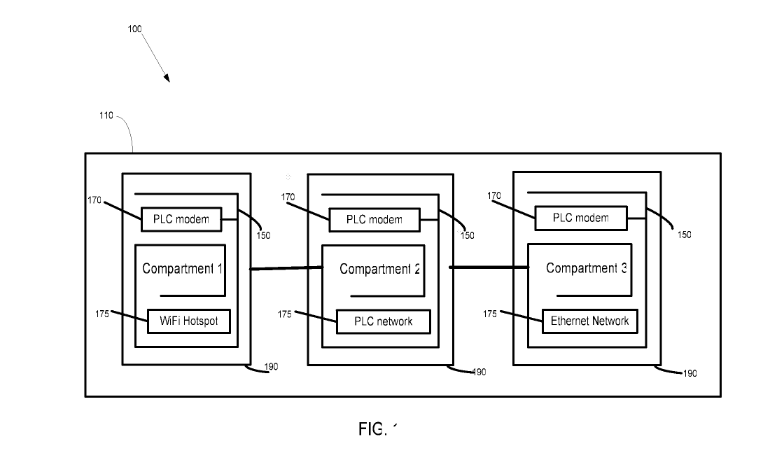

Reference is now made to FIG. 1 which is a schematic block diagram illustration of a communications system 100, according to some embodiments. As can be seen in FIG. 1, system 100 may include, for example, a vehicle 110, for example, a train, plane, ship, tram etc., including multiple compartments. Each compartment (compartments 1-3) may include an electric grid 150, which is connected to one or more power line communications (PLC) modems 170. Each compartment may include a communications network, for example, a WiFi hotspot 175, power line communications (PLC) network 176, Ethernet network 177 etc.

System 100 may optionally include a network management unit, which may be connected to vehicle 110 through an electric grid, a wireless connection, cable connection, satellite connection, the Internet, communications modem or any other relevant connection. A Network management unit may enable management of communications system 100, for example, a vehicle based data network, for example, including control and monitoring functions for system 100. A Network management unit may enable a vehicle network to be in communication with external data networks, such as the Internet, via satellite, wireless technology, fiber optic lines, electricity lines, telephone lines or other suitable connection infrastructures.

PLC modem 170 may be any communications unit that may provide an Internet or data connection between the electrical outlet and a PC or other peripheral. The unit may have a connector to a PC (e.g., USB or Ethernet connection) and may have optional telephony. PLC modem 170 may include, for example, a learning system, that may enable automatic network configuration. In one example, compartments of a vehicle may be swapped or otherwise changed, and modems 170 may be able to reconfigure themselves to maintain communication between the various modems in a network. In another example, modems 170 may be able to reconfigure themselves to maintain communication between the various modems in a network in changing environments, for example, in accordance with changing geographical landscapes, climatic conditions, population densities etc. An example of modem 170 is the any dedicated PLC modem, by Mainnet Communications of Ra'anana, Israel. In one example PLC modem MAC PLUS, by Mainnet Communications of Ra'anana, Israel, may be used. Other suitable modems or communications boxes may be used.

In some embodiments, a communications network for vehicle 110 may be established, managed, controlled and monitored, for example, from a central computer on the vehicles, or in any other location that is connectable to the vehicles communication network. For example, IP cameras can be placed in each compartment of a train and viewed or otherwise operated from a central control facility in a train, from a train company's central office, or any other relevant location. The system may, for example, collect alarm signals, messages, data etc. from devices or systems implemented in one or more compartments of a vehicle. Data may be stored and processed in a vehicle's computer system, a centralized system or in other relevant system.

According to some embodiments, a vehicle network may be configured using existing electricity wires connecting the compartments. For example, the compartment wire grid(s) may be used to transmit light signals, safety information, service warnings, passenger alerts, multimedia, communications data or other data between compartments and from the vehicle to an external network.

Of course, other structures, elements and dimensions may be used.

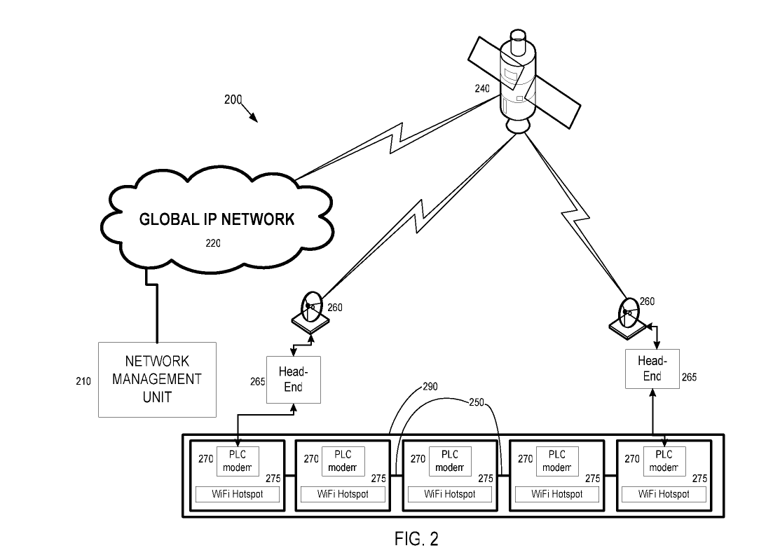

Reference is now made to FIG. 2 which is a schematic block diagram illustration of a communications system 200, according to some embodiments. As can be seen in FIG. 2, system 200 may include, for example, a satellite communications system (e.g., a high speed satellite system) 240, which may be connected wirelessly to a global IP network 220. Satellite system 220 may transmit and/or receive data to/from one or more satellite transponders 260. A Head End 265 or module for collecting and consolidating data from a power source may be coupled to or associated with transponder 260. Head End 265 may communicate with one or more power line communications (PLC) modems 270, which may be connected to a power grid of one or more compartments of a vehicle, for example, train 290. PLC modem 270 may be coupled or associated with a WiFi hotspot 275 or other communications network infrastructure, such that modem 270 is coupled to or associated with the electric grid of the mobile location, for example, electric grid 250 of train 290. A network management system 210 may be connected to IP network 220, to enable control and monitoring functions for system 200. System 200 may enable data to be transmitted from IP network 220 to train 290, and from train 290 to IP network 220, for example by combining satellite transmissions and receipts of data with wireless technology (e.g., WiFi hotspots). Additionally, PLC modem 270 may enable data to be communicated between compartments of train 290, using electric grid 250, thereby enabling a single satellite transponder 260 to provide data communications to multiple train compartments. In some embodiments repeater units may be used to strengthen signals along the grid.

Head End 265 may be, for example, located in the vicinity of a low voltage transformer, and may be used to transform the data from the communications backbone via the satellite or any other external wireless system, to Head End 265 and from Head End 265 over the electricity grid to the PLC modem(s) and WiFi Hot spot(s) and vice versa. An example of Head End 265 is the PLUS, manufactured by Mainnet Communications of Ra'anana, Israel. Other suitable head ends may be used, and any suitable number of head ends may be used.

PLC modem 270 may be any unit that may provide an Internet or data connection between the electrical outlet and a PC or other peripheral. The unit may have a connector to a PC (e.g., USB or Ethernet connection) and may have optional telephony. PLC modem 270 may include, for example, a learning system, that may enable automatic network configuration. In one example, compartments of a vehicle may be swapped or otherwise changed, and modems 270 may be able to reconfigure themselves to maintain communication between the various modems in a network. In another example, modems 270 may be able to reconfigure themselves to maintain communication between the various modems in a network in changing environments, for example, in accordance with changing geographical landscapes, climatic conditions, population densities etc. An example of modem 270 is a dedicated PLC modem, by Mainnet Communications of Ra'anana, Israel. In some embodiments a MAC PLUS modem, by Mainnet Communications of Ra'anana, Israel, may be used, to enable intelligent routing in a power line network. Other suitable modems may be used.

In some embodiments, a train communications network may be established, managed, controlled and monitored, for example, from a central computer on the train or in any other location that is connectable to the Internet. For example, IP cameras can be placed in each compartment and viewed or otherwise operated from a central control facility in the train, from the train company's central office, or any other relevant location. The system may, for example, collect alarm signals, messages, data etc. from devices or systems implemented in one or more compartments of the train. Data may be stored and processed in the train's computer system, a centralized system or in other relevant system.

In some embodiments two or more transponders 260 may be used for a train network. For example, two transponders providing two data channels may be used. Such a configuration may enable optimal or smart data routing, redundancy, load balancing and general data communications capacity while the train is in relatively short tunnels, and smart network configuration when compartments are changed, swapped, re-ordered or otherwise rearranged.

According to some embodiments, other wireless data transmission technologies may be used, in place of or in addition to satellite. For example, WiMax may be used to transmit data to a train and/or receive data communicated from a train, and the PLC modems may enable communications between multiple compartments.

According to some embodiments, a train network may be configured using existing electricity wires connecting the train's compartments. For example, the wires used to transmit light signals to compartments may be used to transmit communications data.

According to some embodiments, system 200 may enable online monitoring of various parameters (e.g., including video monitoring of each compartment) of a multi compartment vehicle, for example, train 290. Monitoring is possible from the train and/or from remote central office. System 200 may provide remote view of the rails to the train's drivers and to the central office via cameras placed alone the rails. System 200 may enable online broadband communication between the train and the control center, thereby providing remote real time monitoring and exchange of information.

According to some embodiments, system 200 may enable e-ticketing, smart reservations and/or other virtual e-commerce activities. For example, system 200 may enable a user to order, update and modify tickets online. System 200 may enable the user to pay for communication time (e.g., Internet usage time), data etc., together or separately form the user's ticket. System 200 may enable monitoring of a user's trip, for example, distance covered, time period traveled, data downloaded, route taken etc. Of course, other structures, elements and dimensions may be used.

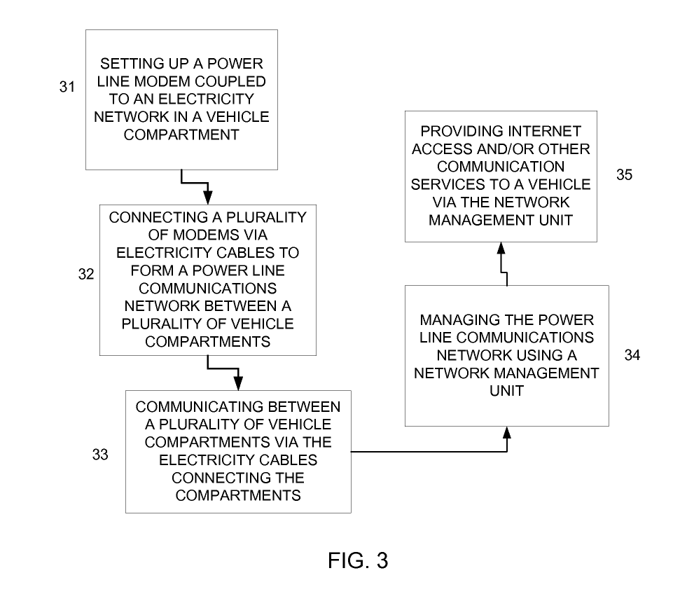

FIG. 3 schematically illustrates a series of operations or processes that may be implemented to provide internet access to mobile locations, such as transportation vehicles. As can be seen in FIG. 3, at block 31, a power line modem may be coupled to an electricity network in a vehicle compartment. At block 32 a plurality of modems may be connected via electricity cables, to form a power line communications network between a plurality of vehicle compartments. At block 33 communicating may be implemented between a plurality of vehicle compartments via the electricity cables connecting the compartments. At block 34 the power line communications network may be managed using a network management unit. At block 35 Internet access and/or other communication services may be provided to a vehicle, for example, via the network management unit.

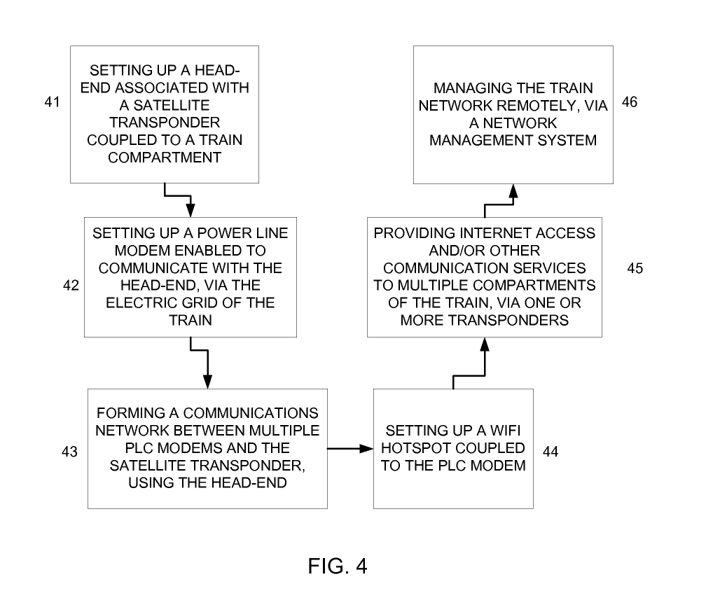

FIG. 4 schematically illustrates a series of operations or processes that may be implemented to provide internet access to mobile locations, such as transportation vehicles. As can be seen in FIG. 4, at block 41, a Head End may be set up associated with a satellite transponder, which may be coupled to a train compartment. At block 42, a power line communications (PLC) modem enabled to communicate with the Head End may be setup, via the electric grid of the mobile location, for example, a train. At block 43 a communications network may be formed between one or more PLC modems and the satellite transponder, using the Head End. One or more Head Ends may be setup on a train. At block 44 a WiFi hotspot may be setup, coupled to the PLC modem. At block 45 wireless Internet access and/or other communication services may be provided to multiple compartments of the train, via one or more transponders. At block 46 the train communications network may be managed remotely, via a central office and/or any other local or remote computing system, for example via a local network or the Internet.

Any combination of the above steps may be implemented. Further, other steps or series of steps may be used. In some embodiments the above described systems and methods may be used in conjunction with push technologies to deliver data to selected destinations. For example, advertisements, multi-media, pod casts etc. may be transmitted to users of trains, busses, aircraft, trams etc. using systems and methods described herein.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is:

1. A communications system for a multi compartment vehicle, comprising:
A plurality of communications networks, at least one communications network for each compartment of said vehicle, wherein each said communications network includes a power line communications modem; and
an electric cable connecting two or more compartments, said modems being coupled to said cable, to enable data to be communicated between said communications modems.

2. The system of claim 1, wherein said vehicle is a train.

3. The system of claim 1, wherein said communications modem includes a learning system that enables automatic network configuration.

4. The system of claim 1, wherein said network management system is adapted to manage communications between a plurality of networks using a plurality of communication mediums.

5. A communications system for a multi compartment vehicle, comprising:
A plurality of communications networks, at least one for each compartment of said vehicle, wherein each said communications network includes a power line communications modem;
A plurality of electric cables connecting two or more compartments, said modems being coupled to said cable, to enable data to be communicated via said cables between said compartments;
A transponder to enable communications between the vehicle and a communications satellite; and
A network management system to manage the communications between said compartments.

6. The system of claim 5, wherein said vehicle is a train.

7. The system of claim 5, wherein said communications modem includes a learning system that enables automatic network configuration.

8. A method providing data communications for a multi-compartmental vehicle, comprising:
setting up a power line modem coupled to a communications network in a vehicle compartment;
connecting a plurality of modems via an electricity grid, to form a power line communications network between a plurality of compartments; and
communicating between a plurality of compartments of the vehicle via the electricity grid connecting the compartments.

9. The method of claim 8, comprising implementing a learning system within said power line modem, to enable automatic network configuration.

10. The method of claim 8, comprising setting up a WiFi hotspot in communication with said modem

11. The method of claim 8, further comprising:
connecting said power line communication network to a transponder adapted to communicate with a communications satellite.

12. The method of claim 11, comprising implementing a learning system within said power line modem, to enable automatic network configuration.

13. The method of claim 11, comprising managing the communications between said compartments using a network management system.
